(19) United States
(12) Patent Application Publication
(10) Pub. No.: US 2024/0168163 A1
(43) Pub. Date: May 23, 2024

(54) OPTICAL SENSOR, METHOD FOR CONTROLLING OPTICAL SENSOR, AND CONTROL PROGRAM FOR OPTICAL SENSOR

(71) Applicant: OMRON CORPORATION, Kyoto-shi, Kyoto (JP)

(72) Inventors: Ryosuke Tsuzuki, Kyoto (JP); Norihiro Tomago, Kyoto (JP); Jumpei Nakamura, Kyoto (JP); Katsushi Takaichi, Kyoto (JP)

(21) Appl. No.: 18/549,311

(22) PCT Filed: Dec. 20, 2021
(86) PCT No.: PCT/JP2021/046927

§ 371 Date: Sep. 6, 2023

(30) Foreign Application Priority Data
Mar. 12, 2021 (JP) 2021-040307

(51) Int. Cl. G01S 17/42; G01S 17/894

(52) U.S. Cl. CPC G01S 17/42; G01S 17/894

(57) ABSTRACT

An optical sensor includes a light-projecting element that projects detection light; an optical axis adjustment element that adjusts an optical axis of the detection light; a light-receiving element that receives the detection light reflected at a target object and outputs a detection signal; a reception unit that receives a specified condition relating to a detection result obtained via preliminary detection of a target object; and a control unit that sets, as an inspection direction, a direction of the detection light in which, of detection results based on the detection signal obtained by scanning a preliminary target placed in advance with the detection light by driving the optical axis adjustment element, a detection result corresponding to the specified condition is obtained, and drives the optical axis adjustment element to cause the detection light to be projected, in the inspection direction set, for an inspection target placed instead of the preliminary target.

### BACKGROUND

### Technical Field

The present application relates to an optical sensor, a method for controlling an optical sensor, and a control program for an optical sensor.

### Description of the Related Art

There is a known optical sensor that detects the presence of inspection targets and distances. For example, the Time of Flight (TOF) sensor described in Patent Document 1 detects distance by measuring the amount of time it takes for detection light projected at an inspection target to be reflected and return.

### CITATION LIST

Patent Document 1: JP 2017-53769 A

### BRIEF SUMMARY

An optical sensor may be installed in a manufacturing line and used to measure a portion with a characteristic shape in a product moving along the manufacturing line to determine the product type and/or quality of the product. When used in this manner, the optical sensor is often attached to a structure that is part of the manufacturing line. However, the optical sensor cannot be attached near the inspection target in all cases. Accordingly, a wide-range optical sensor with a detection range of several meters has been developed in recent years. However, with wide-range optical sensors, even a slight angle error arising at the time of attachment causes the detection light to deviate from a target section of the inspection target. Exact adjustment of the optical axis of the detection light is difficult when the optical sensor is attached by using an attachment fixture. To perform this adjustment, a worker is required to loosen and tighten the attachment fixture while checking the spot formed by the detection light, which is a cumbersome task.

The present disclosure has been made to solve the aforementioned problems and provides an optical sensor and the like that do not require a cumbersome optical axis adjustment task when used to detect a detection target that is relatively far away.

An optical sensor according to a first aspect of the present disclosure includes: a light-projecting element configured to project detection light; an optical axis adjustment element configured to adjust an optical axis of the detection light projected from the light-projecting element; a light-receiving element configured to receive the detection light reflected at a target object and output a detection signal; a reception unit configured to receive, in advance, a specified condition relating to a detection result obtained via preliminary detection of a target object; and a control unit configured to set, as an inspection direction, a direction of the detection light in which, of detection results based on the detection signal obtained by scanning a preliminary target placed in advance with the detection light by driving the optical axis adjustment element, a detection result corresponding to the specified condition received by the reception unit is obtained, and drive the optical axis adjustment element to cause the detection light to be projected, in the inspection direction set, for an inspection target placed instead of the preliminary target, and cause the light-projecting element and the light-receiving element to perform detection processing. According to the optical sensor configured in this manner, by the user setting the specified condition relating to the target object in advance, the detection direction for the optical sensor to perform detection processing can be automatically set. This relieves the user of the task of readjusting the orientation of the optical sensor and the like.

The optical sensor described above may have a configuration in which the reception unit receives a condition relating to distance as the specified condition. For example, in a case in which a target section of the inspection target is a section that projects toward the sensor, the “nearest section” can be specified as the specified condition. In this manner, the specified condition can be intuitively set according to the characteristic of the target section.

In the optical sensor described above, the control unit may perform a notification projection of projecting the detection light in the inspection direction set in a manner that the detection light is visually recognizable by a user. By performing the notification projection, the user can confirm which direction has been set as the detection direction.

The optical sensor described above may further include a display unit configured to show the inspection direction set by the control unit. With such a display unit, the user can confirm which direction has been set as the detection direction.

In the optical sensor described above, the control unit may use, of detection results obtained by scanning with the detection light, a detection result obtained near the inspection direction set and set a detection condition of detection processing for the inspection target. Since the detection results near the inspection direction set are also obtained by scanning, this information may be used to set the detection condition of the detection processing, enabling detection processing appropriate for the shape or the like of the inspection target.

A method for controlling an optical sensor according to a second aspect of the present disclosure is a method for controlling an optical sensor including a light-projecting element configured to project detection light, an optical axis adjustment element configured to adjust an optical axis of the detection light projected from the light-projecting element, and a light-receiving element configured to receive the detection light reflected at a target object and output a detection signal, the method including: a reception step of receiving, in advance, a specified condition relating to a detection result obtained via preliminary detection of a target object; a scanning step of scanning a preliminary target placed in advance with the detection light by driving an optical axis adjustment element and obtaining a plurality of detection results based on the detection signal; a setting step of setting, as an inspection direction, a direction of the detection light in which, of the plurality of detection results obtained in the scanning step, a detection result corresponding to the specified condition received in the reception step is obtained; and an inspection step of driving the optical axis adjustment element to cause the detection light to be projected, in the inspection direction set, for an inspection target placed instead of the preliminary target and causing the light-projecting element and the light-receiving element to perform detection processing.

A control program for an optical sensor according to a third aspect of the present disclosure is a control program for an optical sensor including a light-projecting element configured to project detection light, an optical axis adjustment element configured to adjust an optical axis of the detection light projected from the light-projecting element, and a light-receiving element configured to receive the detection light reflected at a target object and output a detection signal, the program causing a computer to execute: a reception step of receiving, in advance, a specified condition relating to a detection result obtained via preliminary detection of a target object; a scanning step of scanning a preliminary target placed in advance with the detection light by driving an optical axis adjustment element and obtaining a plurality of detection results based on the detection signal; a setting step of setting, as an inspection direction, a direction of the detection light in which, of the plurality of detection results obtained in the scanning step, a detection result corresponding to the specified condition received in the reception step is obtained; and an inspection step of driving the optical axis adjustment element to cause the detection light to be projected, in the inspection direction set, for an inspection target placed instead of the preliminary target and causing the light-projecting element and the light-receiving element to perform detection processing.

According to the second and third aspect, in a similar manner to the first aspect, by the user setting the specified condition relating to the target object in advance, the detection direction for the optical sensor to perform detection processing can be automatically set. This relieves the user of the task of readjusting the orientation of the optical sensor and the like.

The present disclosure can thus provide an optical sensor and the like that do not require a cumbersome optical axis adjustment task when used to detect a detection target that is relatively far away.

### BRIEF DESCRIPTION OF THE SEVERAL VIEWS OF THE DRAWINGS

FIG. 1 is a perspective view illustrating the appearance of an optical sensor.

FIG. 2 is a system configuration diagram of the optical sensor.

FIG. 3 is a diagram illustrating an example of a specified condition to be input.

FIG. 4 is a diagram illustrating how a search and scan is performed on a preliminary target.

FIG. 5 is a diagram illustrating a state when an inspection direction is set.

FIG. 6 is a diagram illustrating the setting of a detection condition in detection processing.

FIG. 7 is a diagram illustrating how an inspection target is inspected.

FIG. 8 is a flowchart illustrating the processing steps of a control unit.

### DETAILED DESCRIPTION

Hereinafter, the present disclosure will be described in the form of embodiments of the disclosure, but the claims are not limited to the following embodiments. In addition, not all of the configurations described in the embodiments are essential to solving the problem.

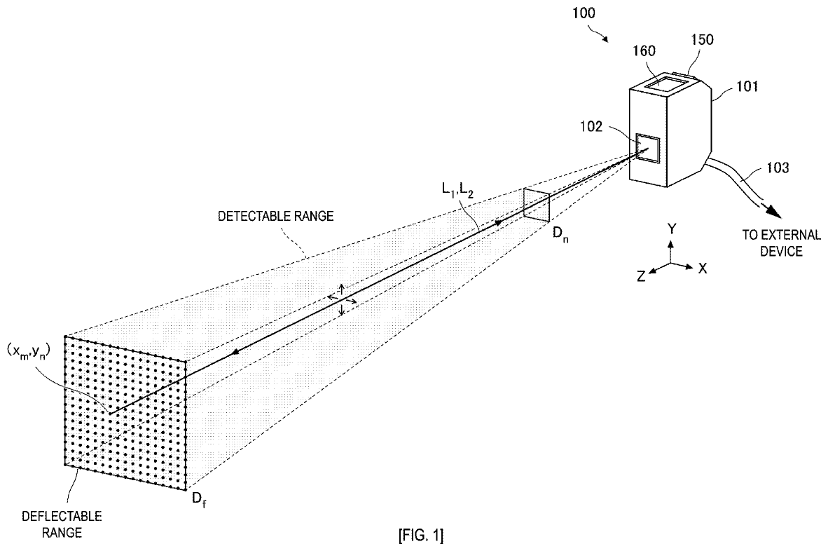

FIG. 1 is a perspective view illustrating the appearance of an optical sensor 100. The optical sensor 100 according to the present embodiment is a sensor that detects the presence of the shape of a portion of a workpiece corresponding to the inspection target, the distance to a specific section, and the like. The optical sensor 100 is installed and used in a manufacturing line in a factory or the like, for example. The optical sensor 100 projects detection light L₁ toward the workpiece and receives detection light L₂ that is reflected at the workpiece and returns. More particularly, the optical sensor 100 described below is a time-of-flight (TOF) sensor that obtains distance information by measuring, to detect the distance to the workpiece, the amount of time it takes for detection light to travel to and return from the workpiece. In a case in which the optical sensor 100 cannot receive the detection light L₂, the optical sensor 100 outputs not-detected information indicating that the workpiece has not been detected. In a case in which the optical sensor 100 can receive the detection light L₂, the optical sensor 100 outputs distance information.

The detection light L₁ is projected through a transmission window 102 provided on one surface of a housing 101. The optical sensor 100 includes an optical axis adjustment element that adjusts the projection direction of the detection light L₁ projected from a light-projecting element. Details of this will be described below. The optical axis adjustment element can deflect the optical axis of the detection light L₁ in two orthogonal axis directions (the illustrated X-axis direction and Y-axis direction) at a predetermined pitch. Specifically, as illustrated, the optical axis of the detection light L₁ can be aligned with a discretionary direction (xₘ, yₙ) indicated by dots within a deflectable range.

In addition, the optical sensor 100 can detect distance within a range from Dₙ to D_{f} in the projection direction of the detection light L₁. In other words, the range indicated by the halftone dots in the diagram is the detectable range, and the optical sensor 100 outputs not-detected information when no workpiece is in this range and outputs distance information of the distance to the reflection point of the detection light L₁ when a workpiece is in this range.

An operation button 150 is provided on one surface of the housing 101 and receives an operation from a user. A display panel 160 is provided on one surface of the housing 101, and the set inspection direction and the like as described below are displayed on the display panel 160. A cable 103 is connected to an external device such as a PLC or a PC, and, through the cable 103, an output signal is transmitted to these devices. An X-axis, a Y-axis, and a Z-axis are defined as illustrated in the figures. In some of the diagrams described below, the same coordinate axes as in FIG. 1 are also illustrated to indicate the orientation of the components illustrated in those diagrams.

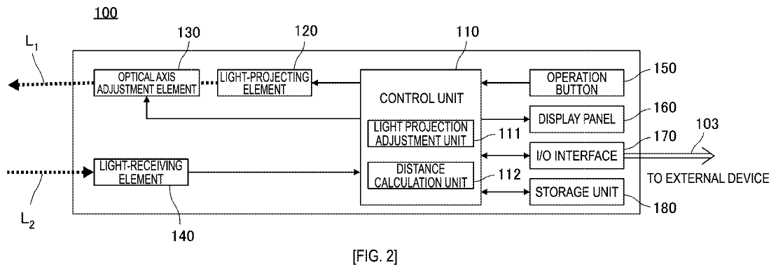

FIG. 2 is a system configuration diagram of the optical sensor 100. The control system of the optical sensor 100 primarily includes a control unit 110, a light-projecting element 120, an optical axis adjustment element 130, a light-receiving element 140, the operation button 150, the display panel 160, an I/O interface 170, and a storage unit 180. The control unit 110 is a processor (central processing unit (CPU)) that controls the optical sensor 100 and performs processing of executing programs. The control unit 110 may include an arithmetic processing chip such as an application specific integrated circuit (ASIC) or a processing circuit that processes various kinds of electrical signals. The control unit 110 executes a control program read out from the storage unit 180 or provided by an external device via the I/O interface 170 to perform various processing relating to the workpiece detection processing.

The light-projecting element 120 is a laser diode that emits a laser beam (e.g., red light ranging from 635 nm to 680 nm) and emits the detection light L₁, a frequency of which is modulated to a specific frequency (e.g., 12 MHz) under the control of the control unit 110. When the wavelength band of the detection light L₁ is a visible band, the spot formed by the detection light L₁ incident on the workpiece can be visually recognized. This helps in checking the progress of search and scan with the detection light L₁ and in checking an inspection section where inspection processing is being performed. Note that the light-projecting element 120 is not limited to a laser diode that emits coherent light and may be an element that emits incoherent light, such as an LED.

As described above, the optical axis adjustment element 130 is an element that adjusts the optical axis of the detection light L₁ projected from the light-projecting element 120. In the present embodiment, a liquid crystal device is used as the optical axis adjustment element 130. The liquid crystal device implements deflection by applying a voltage to a liquid crystal cell to control the on/off state of the liquid crystal cell. Specifically, the liquid crystal device is a device including layers of liquid crystal diffraction gratings (e.g., Journal “Optics”, Vol. 30, Issue 1: “Research Trends in Liquid Crystal Optical Devices”, p. 6), each including an array of liquid crystal cells. The liquid crystal device further includes a control circuit that controls the voltage applied to the liquid crystal cells. The control circuit is embedded in the liquid crystal device such that the amount of deflection of the incident laser beam can be controlled in accordance with an input control signal. In addition, a MEMS mirror, an optical phased array, an electro-optic crystal, or the like can also be used as the optical axis adjustment element 130. If light other than visible light can be used, slow light using near-infrared light or the like may be used.

The light-receiving element 140 is, for example, a CMOS sensor including a two-dimensional array of photoelectric conversion pixels. The light-receiving element 140 converts the received detection light L₂ into an electrical signal and transmits the electrical signal to the control unit 110. Note that, in FIG. 2, the detection light L₁ projected toward the workpiece and the detection light L₂ received at the light-receiving element 140 are illustrated with different optical paths but actually have the same optical path as illustrated in FIG. 1, and, for example, a dichroic mirror is used to separate the optical path of the detection light L₂ traveling toward the light-receiving element 140 from the optical path of the detection light L₁. In addition, since the optical axis adjustment element 130 is housed inside the housing 101 together with the light-projecting element 120 and the light-receiving element 140, there is no need to provide a movable portion for adjusting the optical axis of the detection light L₁ outside of the housing 101. Accordingly, the housing 101 can be directly fixed to the structure that is part of the manufacturing line, for example, making installation of the optical sensor 100 easier and reducing the effect of careless contact or the like by a worker.

The operation button 150 is an operation member that receives instructions from a user and may include, for example, an UP button, a DOWN button, or a directional pad. The operation button 150 functions in cooperation with the control unit 110 as a reception unit that receives, in advance, specified conditions relating to the detection result obtained by preliminary detection of a target object. In addition to functioning as a reception unit as described above, the operation button 150 also functions as a reception unit of the optical sensor 100 that receives the input of various items. Note that the operation member is not limited to an operation button and may be another device such as a touch sensor.

The display panel 160 is, for example, a liquid crystal panel and displays the setting state of the optical sensor 100, distance information or not-detected information as the detection result, and the like. Note that an LED or the like may be provided as the device for showing the setting state of the optical sensor 100. The I/O interface 170 is an interface for exchanging information with an external device via the cable 103 and includes an Ethernet (trademark) unit or a LAN unit, for example. Note that the I/O interface 170 is not limited to an interface for wired connection via the cable 103 and may include a wireless connection unit that supports a wireless LAN or Bluetooth (trademark).

The control unit 110 can also receive an operation performed by the user on an external device via the I/O interface 170. For example, when a user uses the user interface of an external device to specify a specified condition relating to the detection result to be obtained via preliminary detection of a target object, the I/O interface 170 functions as a reception unit in cooperation with the control unit 110.

The storage unit 180 is a non-volatile storage medium and includes a flash memory, for example. The storage unit 180 may store various parameter values, functions, lookup tables, and the like used in control and calculations in addition to programs for performing control and processing of the optical sensor 100. The storage unit 180 stores the specified condition received by the reception unit and the set inspection direction of the detection light L₁.

The control unit 110 also functions as a functional calculation unit that performs various calculations according to the processing instructed by the control program. The control unit 110 may function as a light projection adjustment unit 111 and a distance calculation unit 112. The light projection adjustment unit 111 drives the optical axis adjustment element 130 according to a program command to perform a scan with the detection light L₁ in a changeable range or to project the detection light L₁ in the set inspection direction. The distance calculation unit 112 calculates the time difference between the projected detection light L₁ and the received detection light L₂ using the phase difference between the two and converts this to distance to the inspection target. The control unit 110 arranges the calculation result of the distance calculation unit 112 in accordance with a data structure and outputs the arranged calculation result as distance information. Alternatively, in a case in which the light-receiving element 140 does not receive the detection light L₂, specified not-detected information is output.

The user can specify in advance a specified condition relating to the inspection target via the operation button 150 or the like as described above to set the inspection direction in which the detection light L₁ is to travel. The control unit 110 sets, as the inspection direction, a direction in which a detection result corresponding to the specified condition specified by the user has been obtained, among the detection results obtained by performing a scan with the detection light L₁ of a preliminary target placed in advance. Thereafter, the projection direction of the detection light L₁ is fixed at the set inspection direction, and detection processing for the inspection target is performed. The steps of this processing will be described in detail below.

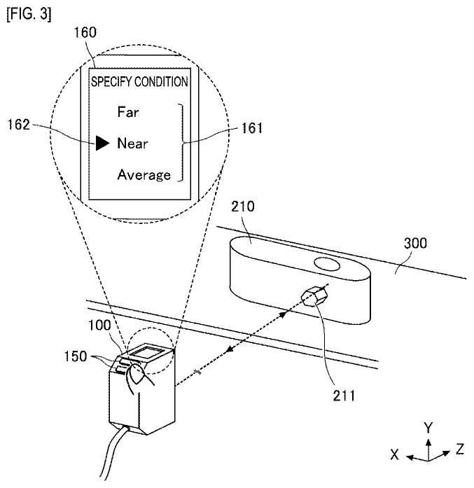

FIG. 3 is a diagram illustrating an example of a specified condition to be input. The optical sensor 100 is fixed to a structure that is part of a manufacturing line, directed toward an inspection position on a manufacturing line 300. The user places a preliminary workpiece 210, which is a preliminary target of the same type as the inspection target for which inspection is planned, on the manufacturing line 300 with an inspection section 211, which is the target, located at or near the inspection position. In this case, it is sufficient that the inspection section 211 is included in the deflectable range of the detection light L₁ and that the user can place the preliminary workpiece 210 roughly in place on the manufacturing line 300 without a significant amount of care.

Note that the preliminary workpiece 210 is desirably a reference product for which the inspection section 211 is determined to be in an acceptable state. The present example assumes a case of inspecting whether a hexagon head screw is acceptably fastened in each workpiece moving in order along the manufacturing line 300. In this case, the inspection section 211 is the head of the hexagon head screw, and the hexagon head screw is desirably fastened correctly in the preliminary workpiece 210.

With the optical sensor 100 and the preliminary workpiece 210 placed in this state, the user operates the operation button 150 to specify a specified condition relating to the inspection target. The conditions that can be specified are listed on the display panel 160 as selection items 161, as illustrated in the diagram. In the illustrated example, the selection items 161 prepared include “Far” for setting the inspection direction to the projection direction with the farthest detected distance, “Near” for setting the inspection direction to the projection direction with the shortest detected distance, and “Average” for setting the inspection direction to the projection direction with the detected distance closest to the average value for all of the detected distances. These selection items are prepared as specific items such that the user can easily make a selection relating to the detection result obtained by preliminary detection of the inspection target.

The user can align a selection indicator 162 with any of the selection items 161 by operating the operation button 150. In the illustrated example, the selection indicator 162 is aligned with “Near”. When the select button is pressed in this state, “Near” is set as the specified condition.

Note that in this example, three conditions are prepared to be selectable, but the options are not limited thereto. For example, the user may be able to input or specify the detection distance with a numerical value. For example, when “3 m 20 cm” is specified, the projection direction with a detected distance closest to this is set as the inspection direction, and when “a range from 3 m 10 cm to 3 m 20 cm” is specified, the projection direction with a detected distance satisfying this range is set as the inspection direction. Also, an option with a condition based on the shape of the target, such as “a section recessed relative to the surroundings,” may be prepared. Furthermore, specifying a specified condition is not limited to receiving operation of the operation button 150, and the control unit 110 may have a configuration in which a specified condition specified by a user using an external device is received via the I/O interface 170.

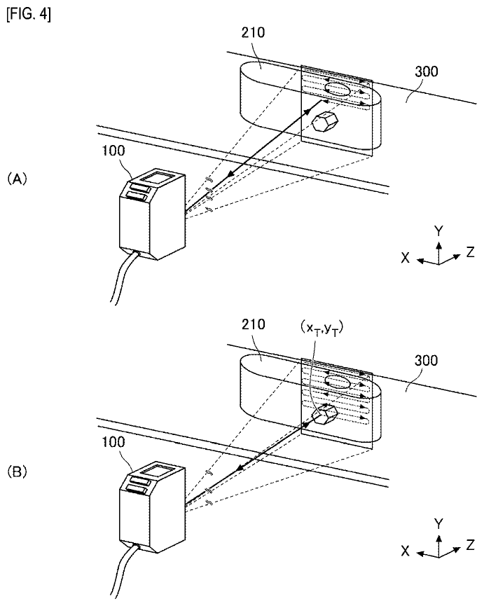

FIG. 4 is a diagram illustrating how a search and scan is performed on the preliminary workpiece 210, which is the preliminary target. When a specified condition is received in advance as described above and a search and scan start instruction is received, the control unit 110 starts a search and scan as illustrated in FIG. 4(A). Specifically, the light projection adjustment unit 111 drives the optical axis adjustment element 130 and sequentially deflects the projection direction of the detection light L₁ from the top left to the bottom right of the deflectable range in one sweep. In synchronization with this, the control unit 110 controls the light-projecting element 120 and the light-receiving element 140 and sequentially stores, in the storage unit 180, the distance information for each projection direction obtained by calculation performed by the distance calculation unit 112 together with the coordinates of the projection direction. For example, as illustrated in FIG. 4(B), when detection processing is performed on the head of a hexagon head screw, direction coordinates (x_{T}, y_{T}) indicating the projection direction of the detection light L₁ at this time and a detected distance D_{T} are stored in the storage unit 180. Note that in the present embodiment, the projection direction of the deflectable detection light L₁ is indicated by the direction coordinates (x, y). However, the parameter for specifying the projection direction is not limited thereto, and the deflection angle about a pitch axis and the deflection angle about a yaw axis may be used.

When the search and scan is complete, a data set of the direction coordinates and distances of the performed detection processing is obtained. Of the obtained distances, the control unit 110 extracts a distance that matches the specified condition specified in advance, and sets the direction coordinates associated with this distance as the inspection direction. Specifically, when “Near” is specified as the specified condition as illustrated in FIG. 3, the control unit 110 sets the direction with the direction coordinates (x_{T}, y_{T}) of the screw head of the preliminary workpiece 210 closest to the optical sensor 100 as the inspection direction.

FIG. 5 is a diagram illustrating a state when an inspection direction is set. After the inspection direction is set, the control unit 110 performs a notification projection that includes projecting the detection light L₁ in the set inspection direction in a manner that the detection light L₁ is visually recognizable by a user. The notification projection is a method of projecting light that is different from the normal method of projecting the detection light L₁, with examples including increasing the output intensity, projecting a blinking light, and the like. In this manner, a highly visible spot can be formed at the inspection section 211, and the user can confirm the section where the inspection is to be performed.

Further, the control unit 110 displays the set inspection direction on the display panel 160 in a simplified manner. Specifically, in a display region of the display panel 160, a range frame 163 indicating the deflectable range is displayed, and a direction indicator 164 representing which direction in the deflectable range is the inspection direction is displayed at a position relative to the range frame 163. Accordingly, the user can confirm the inspection direction by observing the display panel 160. When the inspection direction is automatically set in this manner, the user can be relieved of the cumbersome task of tightening and loosening the attachment fixture while checking the spot formed by the detection light, even in the case of detecting a detection target that is relatively far from the optical sensor 100.

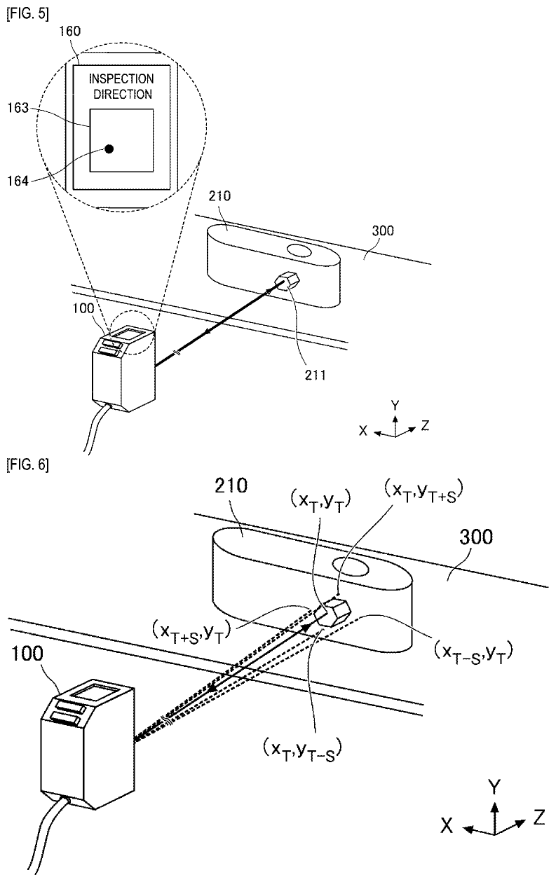

FIG. 6 is a diagram illustrating an example of setting a detection condition in the detection processing. Of the detection results obtained by scanning with the detection light L₁, the control unit 110 can use the detection result obtained near the set inspection direction to set a detection condition of detection processing for the inspection target. For example, when the inspection section has a shape matching the design values, a detection distance is expected to be a distance D₀. In this example, an inspection target with a detection distance D that satisfies (D₀−S)<D<(D₀+S) is considered an acceptable product. Here, S can be defined according to the difference between the distance D_{T} (≈D₀) of the inspection section of the preliminary workpiece 210 and a distance D_{R} of the surroundings.

As illustrated, when the direction coordinates of the inspection direction are determined to be (x_{T}, y_{T}), S is determined according to the detection distance D_{T} and the distance D_{R}, which is the average value of the detection distances at the surrounding direction coordinates. Specifically, a distance D₁ at direction coordinates (x_{T}, y_{T+S}) of a predetermined upper portion relative to the direction coordinates (x_{T}, y_{T}), a distance D₂ at direction coordinates (x_{T-S}, y_{T}) of a predetermined right portion, a distance D₃ at direction coordinates (x_{T}, y_{T-S}) of a predetermined lower portion, and a distance D₄ at direction coordinates (x_{T+S}, y_{T}) of a predetermined left portion are extracted, and the average value of D₁ to D₄ is set as the distance D_{R}. Then, the difference between the distance D_{T} of the inspection section and the calculated distance D_{R} is defined as S. That is, S=D_{T}−D_{R}. When the distance D detected in the inspection direction in inspecting the inspection target satisfies (D₀−S)<D<(D₀+S), a “pass” can be output as the inspection result by the control unit 110. Note that the size and shape of the inspection section is preferably taken into consideration when determining how far to set the direction coordinates of the predetermined upper portion, the predetermined right portion, the predetermined lower portion, and the predetermined left portion from the direction coordinates (x_{T}, y_{T}). For example, specific numerical values may be received from a user in advance, or a range that results in a detection result similar to the detection result of the direction coordinates (x_{T}, y_{T}) may be determined to be on the same plane as the detection section and that plane may be avoided via an automatic setting.

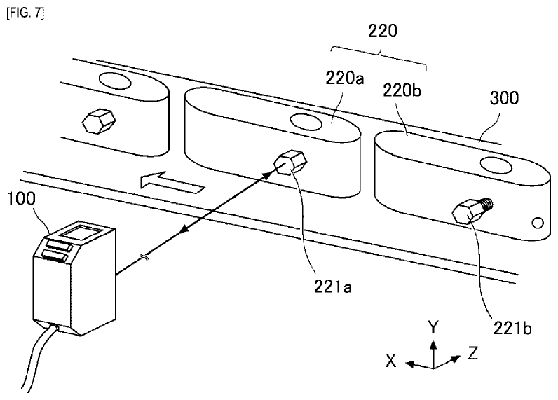

FIG. 7 is a diagram illustrating how an inspection workpiece 220, which is the inspection target, is inspected. When the inspection direction is set as described above, the light projection adjustment unit 111 fixes the set direction coordinates (x_{T}, y_{T}) as the projection direction of the detection light L₁. The user removes the preliminary workpiece 210 and runs operations on the manufacturing line 300 such that the target inspection workpieces 220 sequentially are moved along the manufacturing line 300.

Each time the inspection workpiece 220 arrives at a specified position on the manufacturing line 300, the control unit 110 sends a control command to the light-projecting element 120 and the light-receiving element 140, causes detection processing to be performed, and outputs the detection result to an external device.

In the example described below, the detection distance to an inspection section 221 is simply output as the detection result. As illustrated in the diagram, the hexagon head screw is correctly fastened in an inspection workpiece 220a, and the optical sensor 100 outputs a distance Dₐ to an external device as the detection distance to an inspection section 221a. The external device confirms that the distance Dₐ is within the acceptable range and makes a judgment of “pass”. For example, with the acceptable range set as ±α for the Do described above, (D₀−α)<Dₐ<(D₀+α) corresponds to a “pass”. Here, “α” is a fixed value set in advance. On the other hand, the hexagon head screw in the next inspection workpiece 220b is not sufficiently fastened and is sticking out. Further, the optical sensor 100 outputs a distance D_{b} to an external device as the detection distance to an inspection section 221b. The external device confirms that the distance D_{b} is not within the acceptable range and makes a judgment of “fail”. The example described above results in D_{b}<(D₀−α), which corresponds to a “fail”. In this manner, the acceptability of the inspection workpiece 220 can be judged using the optical sensor 100. The optical sensor 100 may judge pass or fail and output the result to an external device.

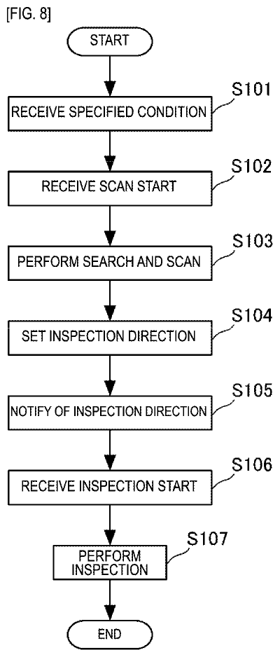

Next, the processing steps of the control unit 110 will be described. FIG. 8 is a flowchart illustrating the processing steps of the control unit 110. The flow starts when the power is turned on, with the optical sensor 100 fixed to a structure that is part of the manufacturing line 300, and the preliminary workpiece 210 placed on the manufacturing line 300.

In step S101, the control unit 110 receives a specified condition relating to the target object via an operation of the operation button 150 by a user. When reception of the specified condition is complete, in the subsequent step S102, an instruction to start scanning is received via an operation of the operation button 150 by the user.

When the instruction to start scanning is received, in step S103, the control unit 110 performs a search and scan of the preliminary workpiece 210. In other words, the light projection adjustment unit 111 drives the optical axis adjustment element 130 to perform scanning using the detection light L₁, the distance calculation unit 112 sequentially calculates the distances while the light-projecting element 120 and the light-receiving element 140 are controlled, and the calculation results are stored in the storage unit 180 together with the direction coordinates.

When the search and scan is complete, the processing proceeds to step S104 where the control unit 110 extracts a distance, of the obtained distances, that matches the specified condition specified in step S101, and sets the direction coordinates associated with this distance as the inspection direction. In the subsequent step S105, the control unit 110 performs a notification projection in the set inspection direction and displays the inspection direction on the display panel 160 in a simplified manner.

In step S106, the control unit 110 waits until an instruction to start inspection is received via an operation of the operation button 150 by a user. When this instruction is received, the processing proceeds to step S107. In step S107, the control unit 110 causes the light projection adjustment unit 111 to align the projection direction of the detection light L₁ with the set inspection direction and causes the light-projecting element 120 and the light-receiving element 140 to perform detection processing each time the inspection workpiece 220 arrives at a specified position on the manufacturing line 300. The control unit 110 outputs the detection result to an external device via the I/O interface 170. When the inspection of the scheduled number of workpieces moving along the manufacturing line 300 is complete, this series of processing ends.

The optical sensor 100 described above receives a condition relating to distance as a specified condition. However, the specified condition may be set to various conditions other than a condition relating to distance, depending on the configuration of the optical sensor. For example, in a case in which a light-receiving element that can detect change in the amount of light received is used, a condition relating to the color of the inspection section may be set as the specified condition because the amount of light reflected changes depending on the color of the reflection section, even when inspection targets are positioned at equal distances from the optical sensor. For example, in a case in which the target object has a surface painted black and a surface that is not painted black, the amount of light reflected is less when light is reflected at the surface painted black. This allows the region painted black to be recognized. In such a case, in a case in which the user sets “amount of light reflected: small” or “amount of light reflected: large” as the specified condition in advance, in a scan and search, “black sections” and “non-black sections” at the same distances can be set as the detection section.

Also, the optical sensor 100 is not limited to a TOF sensor that obtains distance information by measuring, to detect the distance to the inspection target, the time it takes for detection light to travel to and return from the inspection target, and a triangulation sensor may be used that obtains distance information by measuring, to detect the distance to the inspection target, the arrival position of reflected light that changes depending on the distance to the detection target. In a case in which an optical axis adjustment element is used in a triangulation sensor, for example, by preparing in advance a lookup table in which the measured distance is associated with the projection direction of the detection light L₁ and the reception position of the detection light L₂, distance information can be generated as the detection result.

Also, with the optical sensor 100 described above, the range of the search and scan is the entire deflectable range. However, not all of the entire deflectable range necessarily be scanned. For example, the scanning range may be specified by operation of the operation button 150 by a user, or the scanning range may be automatically restricted on the basis of inspection target information sent from an external device. Furthermore, in the embodiment described above, a description is made of a case where the distance information is detected to determine the acceptability of an inspection target. However, the output distance information is not limited to being used to determine acceptability. For example, in another embodiment, the information may be used to judge the product type of the inspection target by detecting distance using a characteristic shape of a portion as the inspection target.

### Supplement

In at least one exemplary embodiment of the present disclosure, an optical sensor (100) includes:
a light-projecting element (120) configured to project detection light (L₁);
an optical axis adjustment element (130) configured to adjust an optical axis of the detection light (L₁) projected from the light-projecting element (120);
a light-receiving element (140) configured to receive the detection light (L₂) reflected at a target object and output a detection signal;
a reception unit (150, 170) configured to receive, in advance, a specified condition relating to a detection result obtained via preliminary detection of a target object; and
a control unit (110) configured to:
set, as an inspection direction, a direction of the detection light in which, of detection results based on the detection signal obtained by scanning a preliminary target (210) placed in advance with the detection light (L₁) by driving the optical axis adjustment element (130), a detection result corresponding to the specified condition received by the reception unit (150, 170) is obtained, and
drive the optical axis adjustment element (130) to cause the detection light to be projected, in the inspection direction set, for an inspection target (220) placed instead of the preliminary target (210) and cause the light-projecting element (120) and the light-receiving element (140) to perform detection processing.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. An optical sensor comprising:
a light-projecting element configured to project detection light;
an optical axis adjustment element configured to adjust an optical axis of the detection light projected from the light-projecting element;
a light-receiving element configured to receive the detection light reflected at a target object and output a detection signal;
a reception unit configured to receive, in advance, a specified condition relating to a detection result obtained via preliminary detection of a target object; and
a control unit configured to
set, as an inspection direction, a direction of the detection light in which, of detection results based on the detection signal obtained by scanning a preliminary target placed in advance with the detection light by driving the optical axis adjustment element, a detection result corresponding to the specified condition received by the reception unit is obtained, and
drive the optical axis adjustment element to cause the detection light to be projected, in the inspection direction set, for an inspection target placed instead of the preliminary target and cause the light-projecting element and the light-receiving element to perform detection processing.

2. The optical sensor according to claim 1, wherein the reception unit receives a condition relating to distance as the specified condition.

3. The optical sensor according to claim 1, wherein the control unit performs a notification projection of projecting the detection light in the inspection direction set in a manner that the detection light is visually recognizable by a user.

4. The optical sensor according to claim 1, further comprising:
a display unit configured to show the inspection direction set by the control unit.

5. The optical sensor according to claim 1, wherein the control unit uses, of detection results obtained by scanning with the detection light, a detection result obtained near the inspection direction set, and sets a detection condition of detection processing for the inspection target.

6. A method for controlling an optical sensor including a light-projecting element configured to project detection light, an optical axis adjustment element configured to adjust an optical axis of the detection light projected from the light-projecting element, and a light-receiving element configured to receive the detection light reflected at a target object and output a detection signal, the method comprising:
a reception step of receiving, in advance, a specified condition relating to a detection result obtained via preliminary detection of a target object;
a scanning step of scanning a preliminary target placed in advance with the detection light by driving an optical axis adjustment element and obtaining a plurality of detection results based on the detection signal;
a setting step of setting, as an inspection direction, a direction of the detection light in which, of the plurality of detection results obtained in the scanning step, a detection result corresponding to the specified condition received in the reception step is obtained; and
an inspection step of driving the optical axis adjustment element to cause the detection light to be projected, in the inspection direction set, for an inspection target placed instead of the preliminary target and causing the light-projecting element and the light-receiving element to perform detection processing.

7. A non-transitory storage medium storing a control program for an optical sensor including a light-projecting element configured to project detection light, an optical axis adjustment element configured to adjust an optical axis of the detection light projected from the light-projecting element, and a light-receiving element configured to receive the detection light reflected at a target object and output a detection signal, the control program causing a computer to execute:
a reception step of receiving, in advance, a specified condition relating to a detection result obtained via preliminary detection of a target object;
a scanning step of scanning a preliminary target placed in advance with the detection light by driving an optical axis adjustment element and obtaining a plurality of detection results based on the detection signal;
a setting step of setting, as an inspection direction, a direction of the detection light in which, of the plurality of detection results obtained in the scanning step, a detection result corresponding to the specified condition received in the reception step is obtained; and
an inspection step of driving the optical axis adjustment element to cause the detection light to be projected, in the inspection direction set, for an inspection target placed instead of the preliminary target and causing the light-projecting element and the light-receiving element to perform detection processing.
